(19) United States
(12) Patent Application Publication
(10) Pub. No.: US 2021/0312365 A1
(43) Pub. Date: Oct. 7, 2021

(54) ANALYSIS OF RESOURCES UTILIZED DURING EXECUTION OF A PROCESS

(71) Applicant: UiPath, Inc., New York, NY (US)

(72) Inventors: Mike de ROODE, Ospeldijk (NL); Roeland Johannus SCHEEPENS, Eindhoven (NL)

(73) Assignee: UiPath, Inc., New York, NY (US)

(21) Appl. No.: 16/840,984

(22) Filed: Apr. 6, 2020

(51) Int. Cl. G06Q 10/06; G06F 11/30; G06F 11/34

(52) U.S. Cl. CPC G06Q 10/06314; G06F 11/3013; G06F 17/18; G06F 11/3452; G06F 11/3476

(57) ABSTRACT

Systems and methods for analyzing resources utilized by a process are provided. An event log of events that occurred during execution of a process is received. The event log identifies resources utilized for each event. Availability of the resources is determined based on the event log. Workload of the resources is determined based on the event log and the availability of the resources. Utilization of the resources is determined based on the availability of the resources and the workload of the resources.

### TECHNICAL FIELD

The present invention relates generally to process management, and more particularly to the analysis of resources utilized during execution of a process to identify resource bottlenecks and resource roles.

### BACKGROUND

Processes are sequences of activities performed to provide products or services. In robotic process automation (RPA), such processes are automated using RPA software robots. In order to optimize performance of such processes by RPA robots, various analyses are often performed. For example, analyzing resources utilized by processes may facilitate the identification of bottlenecks caused by the resources or roles performed by the resources. However, current techniques for analyzing resources utilized by processes are limited and often rely on non-standard information.

### BRIEF SUMMARY OF THE INVENTION

In accordance with one or more embodiments, systems and methods for analyzing resources utilized by a process are provided. A log of events that occurred during execution of a process is received. The log may comprise information of resources utilized for each event. Availability of the resources is determined based on the event log. Workload of the resources is determined based on the event log and the availability of the resources. Utilization of the resources is determined based on the availability of the resources and the workload of the resources. Role of the resources and a hierarchy of the roles are determined based on the event log. The process may be a robotic process automation process.

In one embodiment, the availability of the resources is determined by dividing the event log into timeslots, identifying timeslots during which the events are executed, and determining whether each of the resources are available in each of the timeslots based on the identified timeslots. It is determined whether each of the resources are available in each of the timeslots by comparing a number of the events executed by a particular resource during a particular timeslot over the complete period of the event log, given a particular threshold.

In one embodiment, the workload of the resources is determined by dividing the event log into timeslots, determining a workload of a particular resource for each particular timeslot, and calculating an average of the workloads of the resources. The workload of the particular resource for each particular timeslot may be determined by identifying a set of time points comprising 1) an event start time and an event end time for each event that is executed on the particular resource at any time during the particular timeslot and 2) a start time and an end time of the particular timeslot, determining an initial workload value of the particular resource for each specific time point in the set by 1) multiplying a number of events that are executing on the particular resource at the specific time point with a time difference between the specific time point and an immediately prior time point, and 2) dividing a result of the multiplying by a duration of the particular timeslot, and calculating a sum of the initial workload values for the time points in the set. The event start times may be estimated based on a statistical distribution.

In one embodiment, the utilization of the resources is determined by dividing the event log into timeslots and determining a utilization of a particular resource for each particular timeslot. The utilization of the particular resource for each particular timeslot is determined by identifying a set of time points comprising 1) an event start time and an event end time for each event that is executed on the particular resource at any time during the particular timeslot and 2) a start time and an end time of the particular timeslot, identifying certain time points where a number of events executing at the certain time points is zero, calculating a time difference between each of the certain time points and an immediately prior time point, dividing the time differences by a duration of the particular timeslot, summing results of the dividing, and determining the utilization of the particular resource for the particular timeslot based on the results of the summing.

In one embodiment, the roles of the resources and the hierarchy of the roles are determined by calculating a distance matrix of the resources in the event log, each element of the distance matrix corresponding to a similarity between a pair of the resources, clustering the resources based on the distance matrix to determine the role of each of the resources, and determining a relationship between the clustered resources to determine the hierarchy of the roles.

These and other advantages of the invention will be apparent to those of ordinary skill in the art by reference to the following detailed description and the accompanying drawings.

### BRIEF DESCRIPTION OF THE DRAWINGS

FIG. 1 shows an illustrative process which may be analyzed in accordance with one or more embodiments of the invention;

FIG. 2 shows a framework for performing a resource analysis for a process, in accordance with one or more embodiments of the invention;

FIG. 3 shows a method for performing a resource analysis for a process, in accordance with one or more embodiments of the invention;

FIG. 4 shows an exemplary event log of the process shown in FIG. 1, in accordance with one or more embodiments of the invention;

FIG. 5 shows an exemplary dashboard, in accordance with one or more embodiments of the invention; and

FIG. 6 is a block diagram of a computing system according to an embodiment of the invention.

### DETAILED DESCRIPTION

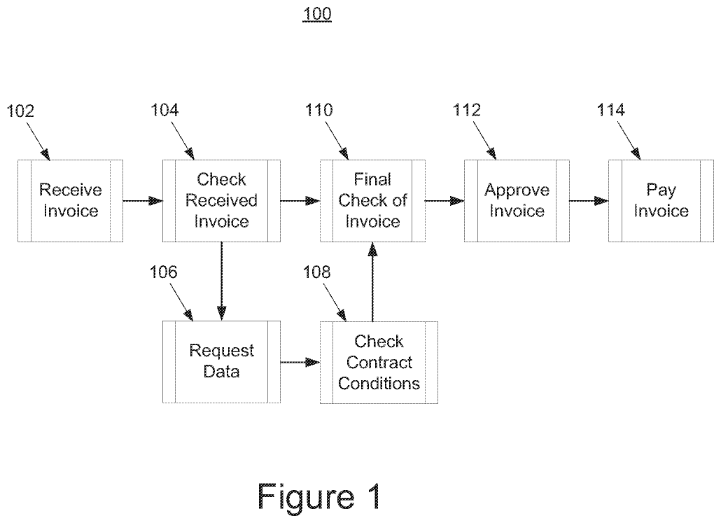

Processes may be utilized to provide products or services for a number of different applications, such as, e.g., administrative applications (e.g., onboarding a new employee), procure-to-pay applications (e.g., purchasing, invoice management, and facilitating payment), and information technology applications (e.g., ticketing systems). An exemplary process 100 is shown in FIG. 1. Process 100 is a process for processing and paying invoices. In one embodiment, process 100 may be implemented as a robotic process automation (RPA) workflow for automatically performing a task using one or more RPA robots.

Process 100 comprises activities 102-114, which represent a predefined sequence of steps in process 100. As shown in FIG. 1, process 100 is modeled as a directed graph where each activity 102-114 is represented as a node and each transition between activities 102-114 is represented as edges linking the nodes. The transition between activities represents the execution of process 100 from a source activity to a destination activity. Execution of process 100 is recorded in the form of an event log.

Process 100 starts at Receive Invoice activity 102 and proceeds to Check Received Invoice activity 104. If the received invoice is determined to be missing information at Check Received Invoice activity 104, process 100 proceeds to Request Data activity 106 and Check Contract Conditions activity 108 before proceeding to Final Check of Invoice activity 110. If the received invoice is determined to not be missing information at Check Received Invoice activity 104, process 100 proceeds directly to Final Check of Invoice activity 110. Process 100 then proceeds to Approve Invoice activity 112 and Pay Invoice activity 114.

In accordance with embodiments of the present invention, resources utilized by process 100 during execution are analyzed in order to improve performance of process 100. In one embodiment, a resource bottleneck analysis is performed on a process to determine resource availability, resource workload, and resource utilization of the process. In another embodiment, a role mining analysis is performed on the process to determine a role for each resource and a hierarchy of the roles. Advantageously, results of such analyses may be used to address resource-related problems encountered by domain experts in practice.

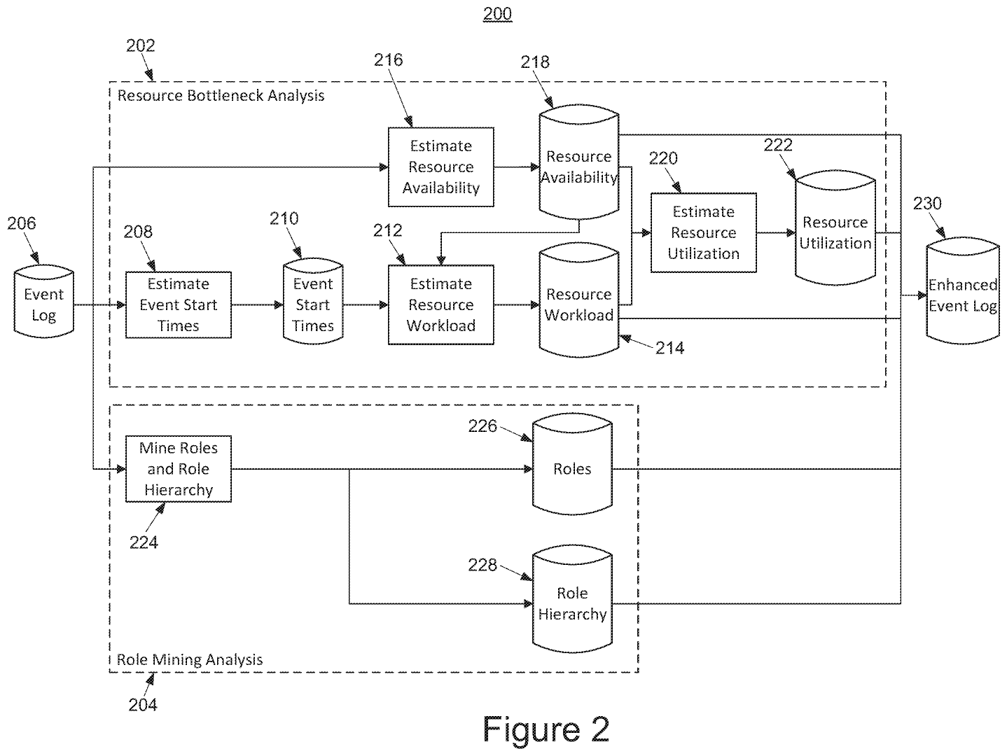

FIG. 2 shows a framework 200 for performing a resource analysis for a process, in accordance with one or more embodiments. Framework 200 comprises a resource bottleneck analysis 202 and a role mining analysis 204. The analyses of framework 200 are performed based on event log 206 of one or more instances of execution of a process, such as, e.g., process 100 of FIG. 1.

In resource bottleneck analysis 202, resource availability 218 is estimated or determined at block 216 using information in event log 206. Resource workload 214 is estimated or determined by first estimating event start times at block 208 using information in event log 206 to provide event start times 210 and estimating or determining resource workloads at block 212 using the event start times 210 and resource availability 218 to provide resource workloads 214. Resource utilization 222 is estimated or determined at block 220 based on resource workload 214 and resource availability 218.

In role mining analysis 204, at block 224, a logical grouping of the resources is determined using information from event log 206 to mine roles 226 of the resources and a hierarchy of the roles is determined using information from event log 206 to mine a role hierarchy 228.

Resource workload 214, resource availability 218, and resource utilization 222 determined in resource bottleneck analysis 202 and roles 226 and role hierarchy 228 determined in role mining analysis 204 are combined with event log 206 to generate an enhanced event log 230. Further processing may be performed based on enhanced event log 230.

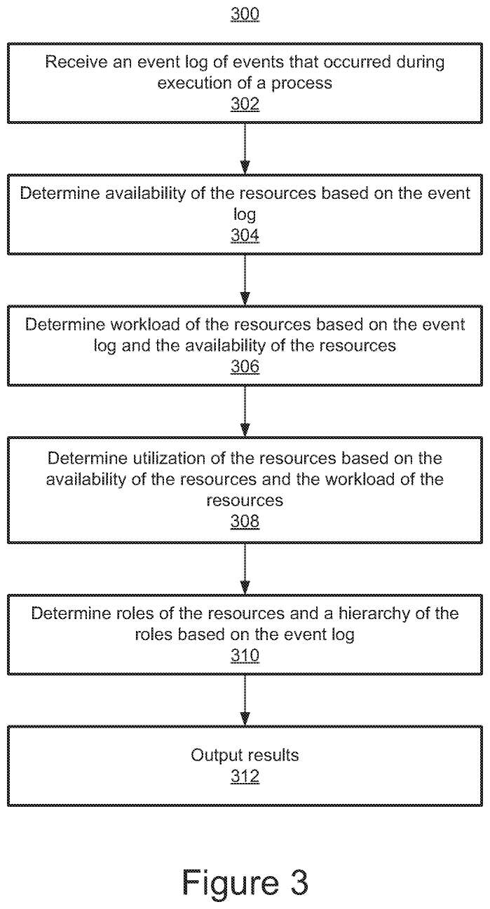

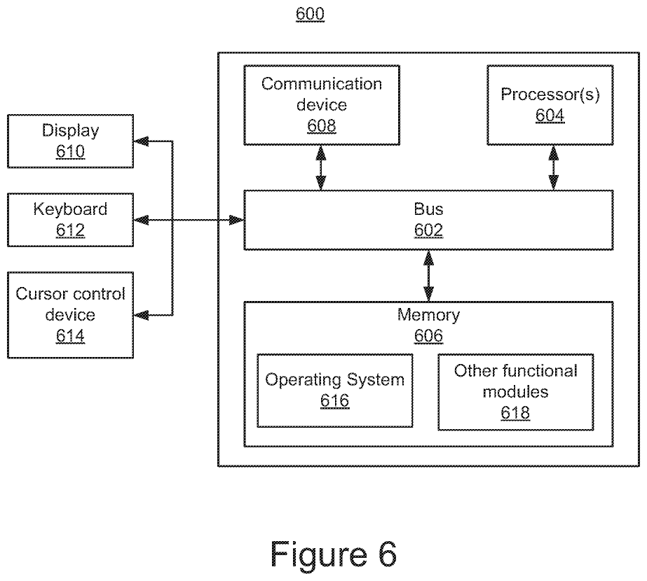

FIG. 3 shows a method 300 for analyzing resources utilized by a process, in accordance with one or more embodiments. Method 300 will be described with continued reference to framework 200 of FIG. 2. Steps 304-308 of method 300 correspond to resource bottleneck analysis 202 of framework 200 and step 310 of method 300 corresponds to role mining analysis 204 of framework 200. The steps of method 300 may be performed by one or more suitable computing devices, such as, e.g., computing system 600 of FIG. 6.

At step 302, an event log of events that occurred during execution of a process is received. An example of the event log is event log 206 of FIG. 2 and an example of the process is process 100 of FIG. 1. The event log may be maintained by recording the events occurring during one or more instances of execution of the process. An event refers to the execution of an activity at a particular time and for a particular case. A case corresponds to a single instance of execution of the process and is identified by a case identifier (ID). In one embodiment, each event may be represented as a tuple comprising a label of an activity that was executed, a time stamp of the execution of the activity, and a case ID identifying the instance of execution of the executed activity. In one embodiment, the event log identifies resources utilized for the execution of each event. An activity of a particular case allocated to a particular resource is referred to as a task. The event log may also include additional attributes for each event.

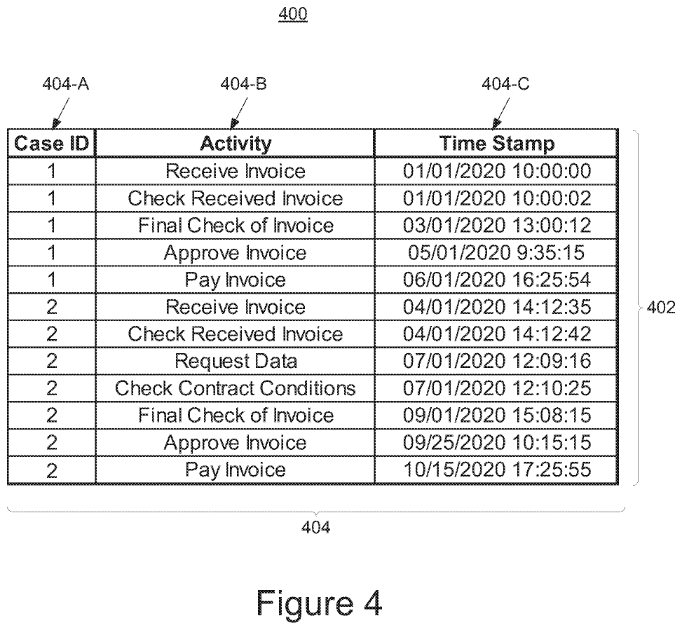

FIG. 4 shows an exemplary event log 400 of process 100 of FIG. 1, in accordance with one or more embodiments. Event log 400 records events occurring during two instances of execution of process 100, corresponding to case ID 1 and case ID 2 in event log 400. As shown in FIG. 4, event log 400 is formatted as a table having rows 402 each corresponding to an event and columns 404 each identifying an attribute of the event at a cell at which rows 402 and columns 404 intersect. In particular, each row 402 is associated with an event representing the execution of an activity 102-114 (identified in column 404-B), a time stamp of the execution of the activity 102-114 (identified in column 404-C), a case ID identifying the instance of execution of the executed activity 102-114 (identified in column 404-A), and a resource ID identifying the resource that executed or performed the activity. The resource may be a person, a machine, or any other resource. In one embodiment, the time stamp of the execution of the activity 102-114, identified in column 404-C, refers to the time at which execution of the activity 102-114 completed, but may alternatively refer to the time at which execution of the activity 104-114 started. It should be understood that event log 400 may be in any suitable format and may include additional columns 404 identifying other attributes of events.

At step 304, availability of the resources is determined based on the event log. In one example, step 304 is performed at block 216 to determine resource availability 218 based on event log 206 in framework 200 of FIG. 2. The availability of each resource is represented as timeslots where that resource is utilized.

In one embodiment, the availability of the resources is determined by first dividing the event log into logical timeslots of equal duration. The timeslots may be any suitable duration that does not exceed the duration of the event log, such as, e.g., a day, a week, a year, etc. In one embodiment, the timeslots are of equal duration during the duration of the event log. In one embodiment, the duration of the timeslots is based on the type of activities executed in the event log. For example, an event log of administrative activities may have timeslots having a duration of one or more days while an event log of industrial production activities may have timeslots having a duration equal to a length of a typical shift of a worker (e.g., 8 hours). Second, the events of the event log are filtered to remove events that are considered to be not relevant. One example of a not relevant event is an automated event that is automatically executed without a resource performing a particular action, since an automated event utilizes system resources. For instance, a not relevant event may be an event executed when a certain wait period has ended. In one embodiment, an automated event may be identified by comparing the throughput time (i.e., the duration) of an event with a threshold (e.g., 1 second). If a throughput time of the event satisfies the threshold (e.g., the throughput time is <1 second), the event is determined to be an automated event and is filtered from the events. The filtered events (i.e., the remaining events) are considered to be relevant events. Third, the timeslots during which the filtered events are executed are identified. In one embodiment, a relevant event is performed during a timeslot when the event end time (e.g., as denoted in the event log) is between the start time and end time of a timeslot. Fourth, for each particular timeslot during which relevant events are performed, it is determined whether the resources are available for work (i.e., active). The timeslots in which a resource is available for work may be estimated based on the number of events the resource typically performs in a timeslot. In one embodiment, a resource is determined to be available for work during a timeslot when the number of events executed by the resource during the timeslot is more than a threshold number of events. If the number of events executed by the resource during a timeslot is above the threshold, it is assumed that the resource is working during this timeslot and therefore the resource is available for work. Accordingly, this step excludes holidays and other days where the resource performed an insignificant number of events from the availability of the resource. The threshold may be a predefined value or may be a resource-specific value. In one embodiment, the threshold is ⅕ of the average number of events per timeslot for the resource, but may be any suitable value. It should be understood that steps one and two are performed once to filter the event log while steps three and four are performed for each timeslot.

At step 306, workload of the resources is determined based on the event log and the availability of the resources. In one example, step 306 is performed at block 212 to determine resource workload 214 based on event log 206 and resource availability 218 in framework 200 of FIG. 2. In one embodiment, the workload of each resource is computed as the average number of events executing at a given time for timeslots in the event log that the resource is available for work.

In one embodiment, the average workload of a resource for a particular timeslot is first determined. First, a chronological ordered list T of all time points tᵢ is created, where list T includes time points tᵢ comprising 1) an event start time and an event end time for each event that is executed on the resource at any time during the particular timeslot, and 2) a start time tsₛ and an end time tsₑ of the particular timeslot. Second, an initial workload value of the resource at the beginning of the timeslot (i.e., all events started before time point tᵢ) is determined for each time point tᵢ by multiplying the number of events that are executing on the resource at time point tᵢ with the time difference (e.g., in seconds) between time point tᵢ and the immediately prior time point tᵢ₋₁, and dividing the resulting value by the duration of the particular timeslot (e.g., in seconds). It should be understood that an event having a start time at time point tᵢ is not considered to be executing yet at time point tᵢ. The workload of the resource for the particular timeslot is determined to be the sum of the initial workload values of the resource for all time points tᵢ.

The workload of the resource is determined as the average of the workload of the resource for each timeslot in the event log that the resource is available for work. The workload of a resource can be repeatedly determined for each resource in the event log to determine the workload of each resource utilized by the process.

In some embodiments, event start times are not identified in the event log. Accordingly, in one embodiment, start times of events are determined based on an estimated event duration of each event. In one example, the start times may be estimated at block 208 to determine event start times 210 of framework 200. To estimate a start time of each particular event, first a lower bound and an upper bound of the start time of the particular event is determined. The upper bounds may be considered to be the end time of the particular event, while the lower bounds may be considered to be the maximum of the end times of all directly preceding events. In processes with parallelism, the immediately prior event may be determined using any suitable process discovery algorithm, such as, e.g., the inductive miner. Next, an event duration estimation model is created using the lower bounds and the upper bounds. In one embodiment, the event duration estimation model is a statistical distribution, such as, e.g., the normal or the negative exponential distribution. The statistical distribution may be determined by randomly sampling events with known start times (e.g., determined by timing the events or measuring the duration of activities by observing the resources). In one embodiment, a statistical distribution is created for each activity, yielding more accurate estimation models.

At step 308, utilization of the resources is determined based on the availability of the resources and the workload of the resources. In one example, step 308 is performed at block 220 to determine resource utilization 222 based on resource availability 218 and resource workload 214 in framework 200 of FIG. 2. The utilization of a resource represents the time that the resource is being utilized. The utilization of a resource is the opposite of the idleness of the resource, and thus can be defined as utilization=1−idleness. Accordingly, the utilization of a resource can be determined based on the idleness of the resource (i.e., the time where the resource is not being utilized).

In one embodiment, the idleness of a resource for a particular timeslot is first determined. First, similar to the determination of the workload of a resource, a chronological ordered list T of all time points tᵢ is created, where list T includes time points tᵢ comprising 1) an event start time and an event end time for each event that is executed on the resource at any time during the particular timeslot, and 2) a start time tsₛ and an end time tsₑ of the particular timeslot. Second, an initial idleness value of the resource at the beginning of the timeslot (i.e., all events started before time point tᵢ) is determined by identifying time points tᵢ where the number of events executing at time point tᵢ is zero (i.e., no events are being executed), determining a time difference (e.g., in seconds) between time point tᵢ and the immediately prior time point tᵢ₋₁ for each identified time point tᵢ, and dividing the time difference by the duration of the particular timeslot (e.g., in seconds) for each identified time point tᵢ. It should be understood that an event having a start time at time point tᵢ is not considered to be executing at time point tᵢ. The idleness of the resource for the particular timeslot is determined to be the sum of the initial idleness values of the resource for all time points tᵢ. The utilization of the resource is determined as utilization=1−idleness. The utilization of the resource is determined as the average of the utilization of the resource for each timeslot the resource is available for work. The utilization of a resource can be repeatedly determined for each resource in the event log to determine the utilization of each resource utilized by the process.

At step 310, roles of the resources and a hierarchy of the roles is determined based on the event log. A role represents a function performed by a logical grouping of similar resources. For example, a role may be a function representing responsibilities of users (e.g., employees) to perform a certain set of activities, such as developer, auditor, etc. A role may be associated with multiple resources and a single resource may have multiple roles. A hierarchy of the roles describes the relationship between the roles and can be defined based on the relationship between the roles. A role may be defined at multiple levels of the hierarchy.

In one embodiment, the role of each of the resources, and the hierarchy of the roles, is determined by first calculating an N×N distance matrix, where N=|res(L)|, where res(L) is the set of resources in the event log L. Each element in the matrix comprises a positive rational number corresponding to a similarity between a pair of resources. For example, a low similarity score may correspond to the resources being highly similar while a high similarity score may correspond to the resources being highly dissimilar. In one embodiment, the similarity score is determined based on the share of executions of a particular activity for each resource. Formally, the share of executions of a particular activity for a resource is the number of times the resource executes the particular activity divided by the number of times the resource executes all activities. In one embodiment, the share of executions of a particular activity for a resource is set to zero when the resources executes the particular activity less than a threshold number of times. The share of executions for all resources is represented as an N×A resource matrix, where N=|res(l)| and A=|act(l)|, such that for each resource there is an activity share for all activities. A distance metric is applied between each pair of resources in the N×A resource matrix, resulting in the N×N distance matrix. Any suitable distance metric may be applied, such as, e.g., the Cosine similarity or the Manhattan distance. Second, the resources are clustered by applying a clustering algorithm on the N×N distance matrix. In one embodiment, an unsupervised clustering algorithm is applied, such as, e.g., centroid-based clustering or density-based clustering. However, any suitable clustering algorithm may be applied. Each cluster is considered to represent one or more roles. To determine the hierarchy of the roles, the clusters are compared to each other to determine whether the clusters are related by a subsume relation. In particular, for each cluster, the average activity share (over all resources) is computed. For each cluster, a set of all other clusters it subsumes is identified, resulting in a set of subsume relations. A cluster c1 is said to subsume another cluster c2 is all activities in c1 are also performed in c2. The set of subsume relations is filtered to remove transitive relationships. For example, where the set of subsume relations indicates that A subsumes B and B subsumes C, the subsume relationship between A and C is deleted. The hierarchy of the rules can be built from the filtered set of subsume relations.

At step 312, results are output. The results may include the availability of the resources, the workload of the resources, the utilization of the resources, the role for each of the resources, and the hierarchy of the roles. In one embodiment, the availability of the resources, the workload of the resources, the utilization of the resources may be used to identify a bottleneck in the resource. In one embodiment, the results may be output by, for example, displaying the results on a display device of a computer system, storing the results on a memory or storage of a computer system, or by transmitting the results to a remote computer system.

In one embodiment, the results are combined with the event log to generate an enhanced event log and the enhanced event log is output. Additional analyses may be performed on the process by processing the enhanced event log.

In one embodiment, the results are output on one or more dashboards displayed to a user on a display device. The dashboards may include, for example, an overview dashboard, a cases dashboard, a process dashboard, a timing dashboard, a user dashboard, and a details dashboard. The overview dashboard depicts a high level view of the event log and links to more detailed dashboards. The cases dashboard depicts a more detailed view on case attributes and case variants. The process and timing dashboards depict an overview of the discovered process model. The process dashboard focuses on the control flow and the timing dashboard focuses on the throughput time of the process. The details dashboard provides a way to explore individual cases.

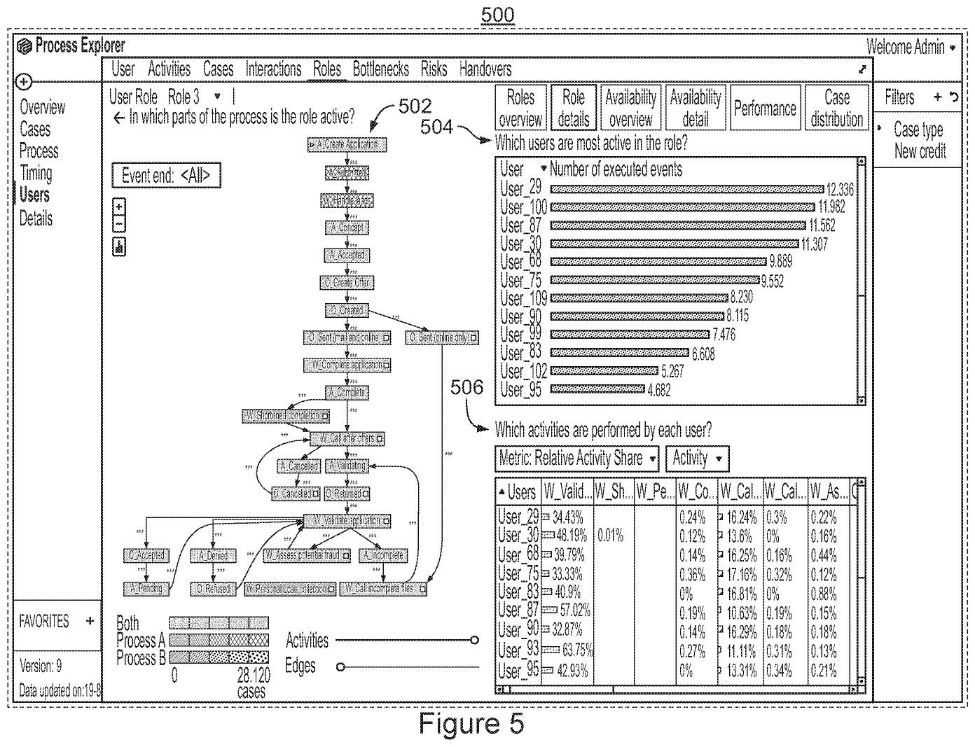

FIG. 5 shows an exemplary dashboard 500, in accordance with one or more embodiments. Dashboard 500 comprises dashboard elements 502, 504, and 506. Dashboard element 502 depicts a model of a process to show participation of activities of the process in a role. In particular, each node in the model corresponds to an activity and each activity is colored to correspond to involvement of that activity in the role. For example, a blue activity may correspond to high involvement of that activity in the role while orange activities may correspond to low or no involvement of that activity in the role. Dashboard element 504 shows the number of executed events per user and dashboard element 506 shows the share of executions of an activity per user.

FIG. 6 is a block diagram illustrating a computing system 600 configured to execute the methods, workflows, and processes described herein, including FIGS. 1-3, according to an embodiment of the present invention. In some embodiments, computing system 600 may be one or more of the computing systems depicted and/or described herein. Computing system 600 includes a bus 602 or other communication mechanism for communicating information, and processor(s) 604 coupled to bus 602 for processing information. Processor(s) 604 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 604 may also have multiple processing cores, and at least some of the cores may be configured to perform specific functions. Multi-parallel processing may be used in some embodiments.

Computing system 600 further includes a memory 606 for storing information and instructions to be executed by processor(s) 604. Memory 606 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media may be any available media that can be accessed by processor(s) 604 and may include volatile media, non-volatile media, or both. The media may also be removable, non-removable, or both.

Additionally, computing system 600 includes a communication device 608, such as a transceiver, to provide access to a communications network via a wireless and/or wired connection according to any currently existing or future-implemented communications standard and/or protocol.

Processor(s) 604 are further coupled via bus 602 to a display 610 that is suitable for displaying information to a user. Display 610 may also be configured as a touch display and/or any suitable haptic I/O device.

A keyboard 612 and a cursor control device 614, such as a computer mouse, a touchpad, etc., are further coupled to bus 602 to enable a user to interface with computing system. However, in certain embodiments, a physical keyboard and mouse may not be present, and the user may interact with the device solely through display 610 and/or a touchpad (not shown). Any type and combination of input devices may be used as a matter of design choice. In certain embodiments, no physical input device and/or display is present. For instance, the user may interact with computing system 600 remotely via another computing system in communication therewith, or computing system 600 may operate autonomously.

Memory 606 stores software modules that provide functionality when executed by processor(s) 604. The modules include an operating system 616 for computing system 600 and one or more additional functional modules 618 configured to perform all or part of the processes described herein or derivatives thereof.

One skilled in the art will appreciate that a “system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like. A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention. Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The foregoing merely illustrates the principles of the disclosure. It will thus be appreciated that those skilled in the art will be able to devise various arrangements that, although not explicitly described or shown herein, embody the principles of the disclosure and are included within its spirit and scope. Furthermore, all examples and conditional language recited herein are principally intended to be only for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future.

What is claimed is:

1. A computer implemented method, comprising:
determining availability of resources utilized for executing events that occurred during execution of a process based on an event log, the event log identifying the resources utilized for each of the events;
determining workload of the resources based on the event log and the availability of the resources; and
determining utilization of the resources based on the availability of the resources and the workload of the resources.

2. The computer implemented method of claim 1, wherein determining availability of resources utilized for executing events that occurred during execution of a process based on an event log comprises:
dividing the event log into timeslots;
identifying timeslots during which the events are executed; and
determining whether each of the resources are available for work in each of the timeslots.

3. The computer implemented method of claim 2, wherein determining whether each of the resources are available in each of the timeslots comprises:
comparing a number of the events executed by a particular resource during a particular timeslot with a threshold.

4. The computer implemented method of claim 1, wherein determining workload of the resources based on the event log and the availability of the resources comprises:
dividing the event log into timeslots; and
determining a workload of a particular resource for each particular timeslot by:
identifying a set of time points comprising 1) an event start time and an event end time for each event that is executed on the particular resource at any time during the particular timeslot and 2) a start time and an end time of the particular timeslot,
determining an initial workload value of the particular resource for each specific time point in the set by 1) multiplying a number of events that are executing on the particular resource at the specific time point with a time difference between the specific time point and an immediately prior time point, and 2) dividing a result of the multiplying by a duration of the particular timeslot, and
calculating a sum of the initial workload values for the time points in the set; and
calculating an average of the workloads of the resources.

5. The computer implemented method of claim 4, further comprising:
estimating the event start times based on a statistical distribution.

6. The computer implemented method of claim 1, wherein determining utilization of the resources based on the availability of the resources and the workload of the resources comprises:
dividing the event log into timeslots; and
determining a utilization of a particular resource for each particular timeslot by:
identifying a set of time points comprising 1) an event start time and an event end time for each event that is executed on the particular resource at any time during the particular timeslot and 2) a start time and an end time of the particular timeslot,
identifying certain time points where a number of events executing at the certain time points is zero,
calculating a time difference between each of the certain time points and an immediately prior time point,
dividing the time differences by a duration of the particular timeslot,
summing results of the dividing, and
determining the utilization of the particular resource for the particular timeslot based on the results of the summing.

7. The computer implemented method of claim 1, further comprising:
determining roles of the resources and a hierarchy of the roles based on the event log.

8. The computer implemented method of claim 7, wherein determining roles of the resources and a hierarchy of the roles based on the event log comprises:
calculating a distance matrix of the resources in the event log, each element of the distance matrix corresponding to a similarity between a pair of the resources;
clustering the resources based on the distance matrix to determine the role of each of the resources; and
determining a relationship between the clustered resources to determine the hierarchy of the roles.

9. The computer implemented method of claim 1, wherein the process is a robotic process automation process.

10. The computer implemented method of claim 1, further comprising:
generating a dashboard for displaying to a user based on at least one of the availability of the resources, the workload of the resources, and the utilization of the resources.

11. An apparatus comprising:
a memory storing computer instructions; and
at least one processor configured to execute the computer instructions, the computer instructions configured to cause the at least one processor to perform operations of:
determining availability of resources utilized for executing events that occurred during execution of a process based on an event log, the event log identifying resources utilized for each of the events;
determining workload of the resources based on the event log and the availability of the resources; and
determining utilization of the resources based on the availability of the resources and the workload of the resources.

12. The apparatus of claim 11, wherein determining availability of resources utilized for executing events that occurred during execution of a process based on an event log comprises:
dividing the event log into timeslots;
identifying timeslots during which the events are executed; and
determining whether each of the resources are available for work in each of the timeslots.

13. The apparatus of claim 12, wherein determining whether each of the resources are available in each of the timeslots comprises:
comparing a number of the events executed by a particular resource during a particular timeslot with a threshold.

14. The apparatus of claim 11, wherein determining workload of the resources based on the event log and the availability of the resources comprises:
dividing the event log into timeslots; and
determining a workload of a particular resource for each particular timeslot by:
identifying a set of time points comprising 1) an event start time and an event end time for each event that is executed on the particular resource at any time during the particular timeslot and 2) a start time and an end time of the particular timeslot,
determining an initial workload value of the particular resource for each specific time point in the set by 1) multiplying a number of events that are executing on the particular resource at the specific time point with a time difference between the specific time point and an immediately prior time point, and 2) dividing a result of the multiplying by a duration of the particular timeslot, and
calculating a sum of the initial workload values for the time points in the set; and
calculating an average of the workloads of the resources.

15. The apparatus of claim 14, further comprising:
estimating the event start times based on a statistical distribution.

16. A computer program embodied on a non-transitory computer-readable medium, the computer program configured to cause at least one processor to perform operations comprising:
determining availability of resources utilized for executing events that occurred during execution of a process based on an event log, the event log identifying resources utilized for each of the events;
determining workload of the resources based on the event log and the availability of the resources; and
determining utilization of the resources based on the availability of the resources and the workload of the resources.

17. The computer program of claim 16, wherein determining utilization of the resources based on the availability of the resources and the workload of the resources comprises:
dividing the event log into timeslots; and
determining a utilization of a particular resource for each particular timeslot by:
identifying a set of time points comprising 1) an event start time and an event end time for each event that is executed on the particular resource at any time during the particular timeslot and 2) a start time and an end time of the particular timeslot,
identifying certain time points where a number of events executing at the certain time points is zero,
calculating a time difference between each of the certain time points and an immediately prior time point,
dividing the time differences by a duration of the particular timeslot,
summing results of the dividing, and
determining the utilization of the particular resource for the particular timeslot based on the results of the summing.

18. The computer program of claim 16, the operations further comprising:
determining roles of the resources and a hierarchy of the roles based on the event log.

19. The computer program of claim 18, wherein determining roles of the resources and a hierarchy of the roles based on the event log comprises:
calculating a distance matrix of the resources in the event log, each element of the distance matrix corresponding to a similarity between a pair of the resources;
clustering the resources based on the distance matrix to determine the role of each of the resources; and
determining a relationship between the clustered resources to determine the hierarch of the roles.

20. The computer program of claim 16, wherein the process is a robotic process automation process.
